(19) United States
(12) Patent Application Publication
(10) Pub. No.: US 2018/0135301 A1
(43) Pub. Date: May 17, 2018

(54) FLOOR GRATE COVER FASTENER/CLAMPING SYSTEM

(71) Applicant: Reliance Industries, LLC, Wheat Ridge, CO (US)

(72) Inventor: William Hasse, Denver, CO (US)

(21) Appl. No.: 15/805,755

(22) Filed: Nov. 7, 2017

Related U.S. Application Data
(60) Provisional application No. 62/422,253, filed on Nov. 15, 2016.

(51) Int. Cl. E04C 2/42; F16M 13/02; F16B 2/12; E04B 1/41

(52) U.S. Cl. CPC E04C 2/428; F16M 13/022; E04B 2001/405; E04B 1/40; F16B 2/12

(57) ABSTRACT

A floor grate fastener/clamping system includes a bracket having a length sized to span the distance between opposite sides of an opening in a floor grate and a J-hook having a pair of non-parallel side members which define hooks adapted to receive the bottom edge of a kick plate. A bolt extends between the bracket and the J-hook, such that rotation of the bolt brings the J-hook and bracket closer to each other, to enable the grate and its associated kick plate to be clamped together by the fastener/clamping system.

### CROSS-REFERENCE TO RELATED APPLICATIONS

This application claims priority to U.S. Pat. App. No. 62/422,253, entitled “Floor Grate Cover Fastener/Clamping System”, filed Nov. 15, 2016, and which is incorporated herein by reference.

### STATEMENT REGARDING FEDERALLY SPONSORED RESEARCH OR DEVELOPMENT

Not Applicable.

### BACKGROUND

This application relates to a fastener/clamping system for securing a floor grate cover over an opening in a floor, and in particular to a fastener/clamping system for use with floor grates wherein a kick-plate is installed around an existing floor opening.

Floor grates can be used as a tread surface to, for example, cover an opening in a floor or form a walk way or the like. In some instances, a kick plate is provided to form a lip or curb for the grating. If the grate is separate from the kick plate, then the grate will need to be secured to the kick plate.

It would be desirable to provide a system for fastening or securing the cover grate to the kick plate which will reduce the likelihood that the grating will become dislodged from the kick plate and which is relatively easy to install.

### BRIEF SUMMARY

A floor grate fastener/clamping system includes a bracket having a length sized to span the distance between opposite sides of an opening in a floor grate and a J-hook having a pair of non-parallel side members which define hooks adapted to receive the bottom edge of a kick plate. A bolt extends between the bracket and the J-hook, such that rotation of the bolt brings the J-hook and bracket closer to each other, to enable the grate and its associated kick plate to be clamped together by the fastener/clamping system.

According to one aspect of the fastener/clamping system, the J-hook comprises a spine from which the side members extend. The J-hook includes an opening formed in the spine sized to accommodate a nut through which the bolt will extend. The nut thus defines a tightening member associated with the J-hook to facilitate movement of the bracket and J-hook relative to each other by rotation of the bolt.

According to one aspect of the fastener/clamping system the side members of the J-hook define an angle of about 5° to about 15° relative to each other.

According to one aspect of the fastener/clamping system the bracket includes a floor in which a bolt hole is formed, walls extending upwardly from the floor, and arms extending outwardly from the walls such that the bracket defines a sunken portion. The walls have a height at least equal to the height of a head of the bolt, such that the bolt head does not protrude above the level of the bracket arms.

According to one aspect of the fastener/clamping system the bracket additionally includes end members extending from the bracket arms. The end members can be canted relative to the bracket arms, such that the end members will extend into openings of the grate adjunct the grate opening through which the bolt passes.

### BRIEF DESCRIPTION OF THE DRAWINGS

FIG. 1 is a perspective view of a floor grate cover fastening system;

FIG. 2 is a side elevational view of the floor grate cover fastening system;

FIG. 3 is a front elevational view of the floor grate cover fastening system;

FIG. 4 is a perspective view of bracket of the floor grate cover fastening system;

FIG. 5 is a front elevational view of the bracket;

FIG. 6 is a top plan view of a blank from which the bracket is formed, with dashed lines showing where bends will be made to form the bracket;

FIG. 7 is a perspective view of a J-clip of the floor grate cover fastening system;

FIG. 8 is a top plan view of the J-clip;

FIG. 9 is a plan view of a blank from which the J-clip is formed, with dashed lines showing where bends will be made to form the J-clip;

FIG. 10 is a perspective view showing the fastener system in use to secure a floor grate to a wall of a floor opening, the wall being shown as clear to see the fastener system;

FIG. 11 is a cross-sectional view through the fastener system taken along line 11-11 of FIG. 10 showing the fastener system in use to secure a floor grate to a wall of a floor opening; and

FIG. 12 is a second cross-sectional view through the fastener system taken along line 12-12 of FIG. 10 showing the fastener system in use to secure a floor grate to a wall of a floor opening.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

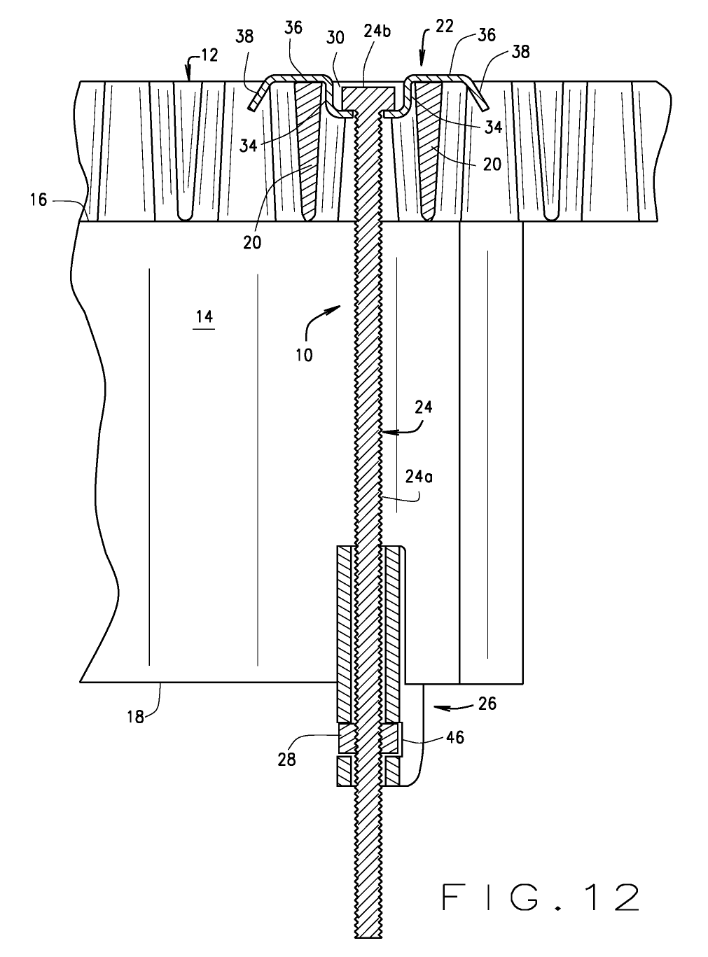

A grate fastener system/assembly 10 is provided to secure a grate 12 to a kick plate 14. As seen in FIGS. 10-12, the kick plate 14 has a top edge 16 upon which the grate 12 rests and a bottom edge 18. The grate 12 comprises bars or dividers 20, which in combination, define openings in the grate 12. Although the grate 12 and kick plate 14 are shown to have a radius (and thus could be circular or oval in shape), the grate fastener assembly 10 can be used with grates and kick plates which define polygons (i.e., triangles, rectangles, pentagons, etc.) whether regular or irregular in shape.

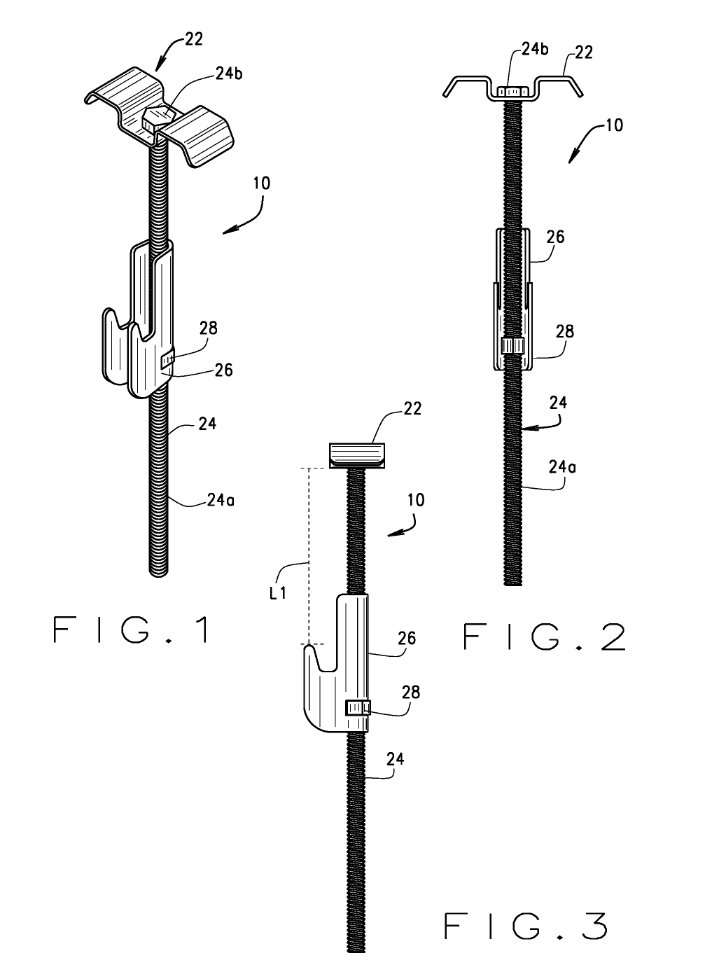

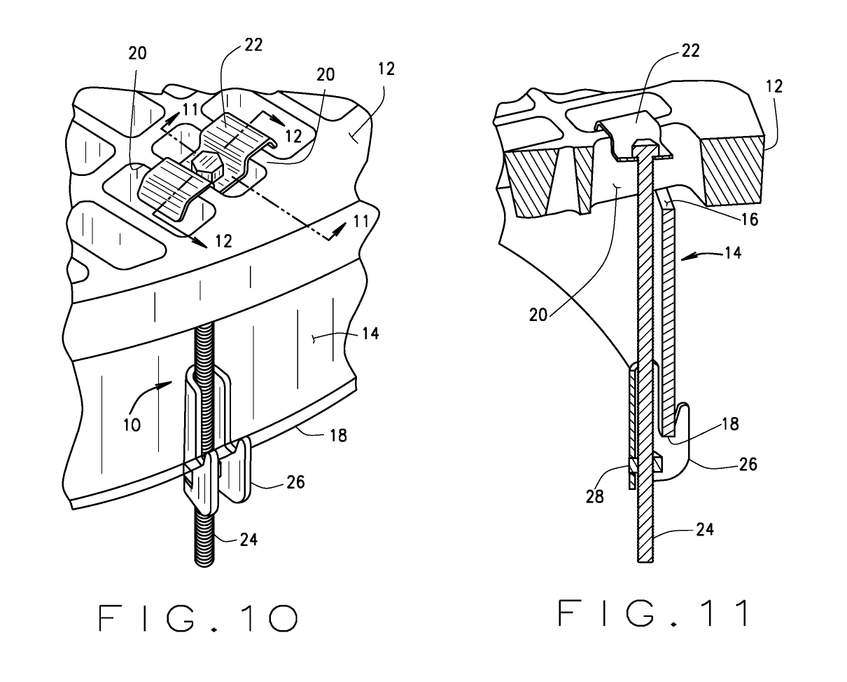

Turning to FIGS. 1-3, the grating fastener system 10 comprises a bracket 22 which is shaped to be received on, and span between, the bars/dividers 20 of the grate 12 (as seen in FIGS. 10-11), a bolt 24 which extends through the bracket 22 and has a length greater than the height of the kick plate 14, a J-hook or clip 26 which captures the bottom edge 18 of the kick plate 14, and a nut 28 which is captured by the J-hook 26 and through which the bolt 24 is threaded. As can be seen in FIGS. 10-12, the fastener system 10 extends between the grate 12 and kick plate bottom edge 18 to sandwich the grate 12 and kick plate 14 between the bracket 22 and J-hook 26. The bolt 24 is placed in tension to hold the grate 12 to the kick plate 14. Although only one fastener system 10 is shown in FIGS. 10-12, it will be appreciated that a plurality of fastener systems 10 will be placed about the periphery of the grate 12 to secure the grate 12 to the kick plate 14.

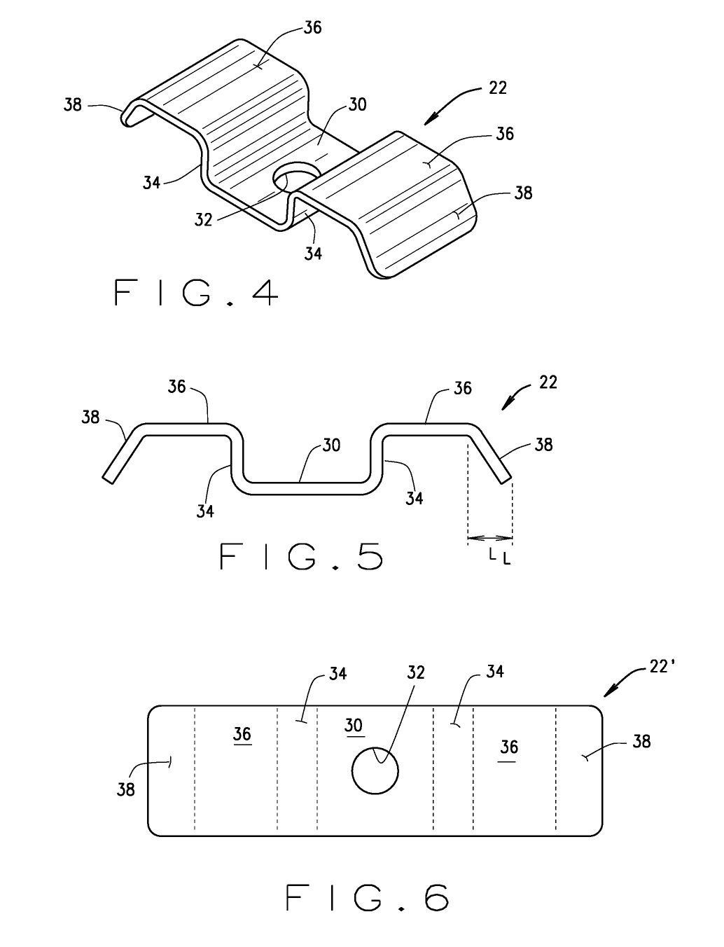

The bracket 22 is shown in greater detail in FIGS. 4-6. The bracket 22 can be formed from any material which will withstand the forces and environment to which the bracket will be subjected. The bracket can be made, for example, from 14 gauge 304 stainless steel. In this case, the bracket 22 can be formed from a stamped plate 22′ (FIG. 6), for example in a bending or stamping operation. Alternatively, the bracket 22 can be formed from plastic or an engineered material which would allow for the bracket to be molded. Alternatively, whether the bracket is made from metal, plastic, or an engineered material, the bracket could be formed by extrusion.

The bracket 22, as formed, comprises a central floor 30 having a hole 32 formed therein. The hole 32 is preferably centered relative to the central floor 30, and is sized to allow for the shaft 24a of the bolt 24 to pass therethrough, but is smaller than the head 24b of the bolt. Side walls 34 extend upwardly from opposite ends of the central floor 30. The side walls 34 have a height at least equal to the height of the bolt head 24b. The central floor 30 is sized such that the distance between the outer surfaces of the side walls 34 substantially span the distance between two opposed dividers 20 of the grate 12. Preferably, there is a slight gap between the outer surfaces of the walls 34 and the surfaces of the divider when the bracket is positioned on the grate to facilitate positioning of the bracket on the grate. In FIGS. 10-12, the walls of the dividers 20 are illustratively shown to be inwardly sloping, and the walls 34 are shown to be generally vertical, thus creating the slight gap between the bracket walls 34 and the dividers 20. An arm 36 extends outwardly from each side wall 34. The arms 36 are generally parallel to the center floor 30 and have a length at least equal to, and preferably greater than, the width of the dividers 20 at the top of the grate 12. Lastly, the bracket 22 includes end members 38 which extend downwardly from the ends of the arms 36. The end members 38 could define right angles with the arms 36, but preferably are canted relative to the arms so as to define obtuse angles with the support arms. For example, the end members 38 can define angles of between about 110° and about 130° with the support arms 36, and preferably about 120°. The end members 38 are sufficiently long to define a length L (FIG. 5) between the end of the support arm 36 and the outer edge of the end member 38 that is less than the width of the gap in the grate 12.

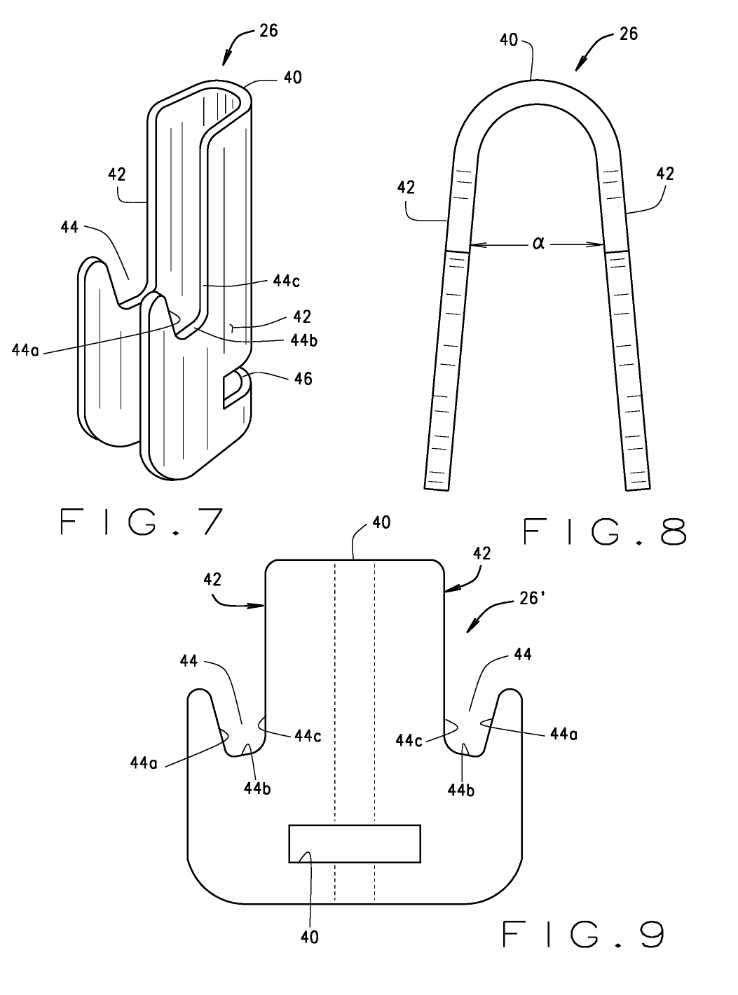

The J-hook 26 is shown in greater detail in FIGS. 7-9. The J-hook 26 can be formed from any material which will withstand the forces and environment to which the bracket will be subjected. The J-hook can be made, for example, from 14 gauge 304 stainless steel. In this case, the J-hook can be formed from a stamped plate 26′ (FIG. 9), for example in a bending or stamping operation. Alternatively, the J-hook 26 can be formed from an engineered material which would allow for the J-hook to be molded.

The J-hook 26 comprises an elongate arced spine 40 defining a radius sufficiently large to receive the bolt shaft 24a. The spine preferably defines an arc of less than, but close to, 180°. J-shaped side members 42 extend from opposite sides of the spine. The two side members 42, therefore, preferably are not parallel to each other. Rather, the side members define an angle α of about 5° to about 15°, and preferably about 10°. As can be appreciated, the arc defined by the spine 40 defines the angle α. The J-shaped side members 42 are identical, and each defines a cutout 44, having front, back, and bottom edges 44a-c giving the side members the J-shaped appearance. The cutout 44, as seen in FIG. 11 is sized to receive the bottom edge of the kick plate 14. Thus, the bottom edge 44b of the cutout has a length at least slightly greater than the material width of the kick plate 14. Thus, the J-hook 26 actually comprises two non-parallel side members 42. Lastly, the J-hook defines a slot 46 centered on the spine 40, but which extends into the side members 42. The slot 46 is sized to receive the nut 28.

Installation of the fastener assembly 10 to a grate and kick plate is relatively easy. Initially, the fastener system 10 is assembled. The bolt shaft 24a is passed through the hole 32 in the bracket 22, and the nut 28 is threaded on to the bolt shaft. The J-hook 26 is then positioned against the bolt shaft with the nut 28 received in the slot 46 of the J-hook. Alternatively, the nut 28 can be positioned in the J-hook prior to threading of the bolt onto the shaft. The nut 28 and J-hook slot 46 are sized relative to each other such that, when the nut is received in the slot, the nut cannot rotate relative to the J-hook 26. As can be appreciated, this allows for rotation of the bolt to alter the distance between the J-hook 26 and the bracket 22. The J-hook 26 is positioned on the bolt, such that the bracket 22 is spaced from the tip of the J-hook 26 a distance L1 (FIG. 3) greater than the height of the kick plate 14. After the grate 12 has been positioned on the kick plate 14, the J-hook 26 is passed through a grate opening that is adjacent to the edge of the kick plate and hooked under the bottom edge 18 of the kick plate 14. The bolt 24 is initially rotated relative to the nut and J-hook to bring the J-hook and bracket towards each other until the bracket 22 is flush against the top of the grate 12. At this point, the bracket 22 will essentially be in the position shown in FIGS. 10-12, with the floor 30 of the bracket between adjacent grate dividers 20 and sunken below the top surface of the grate. The bracket support arms 36 will span the adjacent dividers of the grate. With the bracket 22 and J-hook 26 sandwiching the grate 12 and kick plate 14, the bolt 24 can be further tightened. Preferably, the bolt will be substantially vertical. Thus, if necessary, the bracket 22 can be moved slightly prior to final tightening to ensure that the bolt 24 is as close to vertical as possible. This procedure is then repeated for each fastener assembly used to secure the grate to the kick plate.

The fastener system 10 has three distinct advantages: (1) The recessed floor 32 of the bracket 22 keeps all hardware below the walking surface which reduces a potential tripping hazard and reduces the possibility of shearing the load bearing head of the bolt off; (2) the slotted nut (defined by the nut 28 and the slot 46 in the J-hook 26) helps ensure that when the system is under load, the bolt will remain tightened and reduces the possibility of accidental loosening; and (3) the double legged J-hook 26 (with the non-parallel J-shaped members) substantially prevents the hook 26 from rotating during installation, and substantially prevents slippage during use.

As various changes could be made in the above constructions without departing from the scope of the invention, it is intended that all matter contained in the above description or shown in the accompanying drawings shall be interpreted as illustrative and not in a limiting sense. For example, a portion of the material that is cut from the J-hook blank 26′ to form the opening 46 could remain with the blank, and be bent inwardly. A hole could then be formed in this inwardly directed portion through which the bolt would be threaded. This variation would thus eliminate the need for a separate nut, and would enable the tightening member of the fastener system 10 to be integral with the J-hook 26.

1. A floor grate fastener/clamping system comprising:
a bracket having a length sized to span the distance between opposite sides of an opening in a floor grate; said bracket defining a bolt hole;
a bolt having a head and a threaded shaft; said head having a diameter greater than said bolt hole of said bracket and said shaft being sized to pass through said bolt hole;
a J-hook comprising a spine and a pair of side members extending from said spine such that said side members are not parallel to each other; said side members having cut-outs formed therein such that said side members are hook or J-shaped; and
a tightening member positioned along said J-hook spine and through which said bolt is threaded, whereby, by rotating said bolt in a first direction, the J-hook is brought closer to said bracket.

2. The floor grate fastener/clamping system of claim 1 wherein the J-hook includes an opening formed in said spine, and said tightening member comprises a nut; said opening being sized to receive said nut with said nut being generally perpendicular to said spine and being sized to threadedly receive said bolt.

3. The floor grate fastener/clamping system of claim 1 wherein said side members of said J-hook define an angle of about 5° to about 15° relative to each other.

4. The floor grate fastener/clamping system of claim 1 wherein said bracket includes a floor in which said bolt hole is formed, walls extending upwardly from said floor, and arms extending outwardly from said walls such that said bracket defines a sunken portion; said walls having a height at least equal to the height of said bolt head, such that said bolt head does not protrude above the level of said bracket arms.

5. The floor grate fastener/clamping system of claim 4 wherein said bracket further includes end members extending from said arms; said end members being canted relative to said arms.

6. In combination a kickplate, a floor grate, and a floor grate fastener/clamping system; said kickplate having an upper edge and a lower edge; said floor grate having a plurality of dividers which in combination define openings in the grate; said floor grate fastener/clamping system comprising:
a bracket having a length sized to span the distance between opposite sides of said opening in a floor grate; said bracket defining a bolt hole;
a bolt having a head and a threaded shaft; said head having a diameter greater than said bolt hole of said bracket and said shaft being sized to pass through said bolt hole;
a J-hook comprising a spine and a pair of side members extending from said spine such that said side members are not parallel to each other; said side members having cut-outs formed therein such that said side members are hook or J-shaped and sized to receive the bottom edge of said kick plate; and
a tightening member positioned along said J-hook spine and through which said bolt is threaded, whereby, by rotating said bolt in a first direction, the J-hook is brought closer to said bracket to sandwich said kick plate and floor grate between said bracket and J-hood to thereby secure said floor grate to said kickplate.
